(19) United States
(12) Patent Application Publication
(10) Pub. No.: US 2008/0237509 A1
(43) Pub. Date: Oct. 2, 2008

(54) Piping Member

(75) Inventors: Takashi Yamamoto, Nobeoka-shi (JP); Kenro Yoshino, Nobeoka-shi (JP)

Correspondence Address: BUCHANAN, INGERSOLL & ROONEY PC, POST OFFICE BOX 1404, ALEXANDRIA, VA, 22313-1404, US

(73) Assignee: ASAHI ORGANIC CHEMICALS INDUSTRY CO., LTD., Nobeoka-shi (JP)

(21) Appl. No.: 12/053,905

(22) Filed: Mar. 24, 2008

(30) Foreign Application Priority Data
Mar. 30, 2007 (JP) 2007-090472

(51) Int. Cl. F16K 7/04

(52) U.S. Cl. 251/7

(57) ABSTRACT

A piping device includes a body, a tube accommodated in the body and defining a flow passage, coupling members each having an insert portion, at one end thereof, to be inserted into the tube in a watertight state, a connecting portion at the other end thereof, and a flange portion at the central part thereof, and holding members each formed with a through hole at the central part thereof. The through hole of the holding member includes, at one end thereof, an expanded-diameter portion having a hole diameter larger than the remaining portion of the through hole. The insert portion of each of the coupling members is fitted into the expanded-diameter portion of the corresponding holding member with the tube passed through the through hole of the holding members and each of the insert portions of the coupling members inserted into each of the two ends of the tube, and the flange portion of each of the coupling members and the corresponding holding member pressed into contact with each other are fitted in a fitting groove formed on the body.

### BACKGROUND OF THE INVENTION

1. Field of the Invention

The present invention relates to a piping device having a tube therein used for a pipeline in various industrial fields including chemical plants, semiconductor manufacture, foods and biochemistry, and more specifically to a compact piping device having a short face-to-face length (i.e. a length in a direction of the flow passage axis) and a high sealability between parts connected to the tube so that stress exerted on the pipeline imposes no extraneous load on the tube.

2. Description of the Related Art

A conventional piping device having a tube includes a flow rate controller of a pinch valve structure, as shown in FIG. 6, which is directly connected to the tube and opens/closes the tube at the middle part thereof (for example, see Japanese Unexamined Patent Publication No. 2004-2933769). This flow rate controller includes a case 102 surrounding a middle part of a flexible tube 101 and a male screw 103 for changing the sectional area of the passage in tube 101 by pressing and deforming tube 101 in case 102 substantially at right angles to the tube axis, wherein case 102 includes a first case portion 102a, a second case portion 102b, coupling members 104 for coupling the two case portions so as to be able to be overlaid one on the other and be opened, and lock means 105a, 105b for holding the two case portions in the overlaid state, and wherein at least one of the two case portions has a support portion 106 for supporting the outer peripheral surface of tube 101. This configuration has an effect that flow rate controller 107 can be mounted on or demounted from tube 101 without detaching an end of tube 101 or cutting off tube 101.

The conventional flow rate control valve as shown in FIG. 7 is also available as a pinch valve that can be repeatedly opened and closed or automatically controlled (see, for example, Japanese Unexamined Patent Publication No. 2004-52797). This flow rate control valve includes a valve box constituted by a base member 108 and a cover 109 mounted on base member 108, and a motor 110 disposed in cover 109 of the valve box, wherein a feed screw is directly formed on a downwardly projecting rotary shaft 111 of motor 110 by machining rotary shaft 111, and wherein a space portion is formed on base member 108 so as to extend laterally through base member 108 and a flow passage tube 112 with a cross-sectional shape deformable under a diametrical pressure, but restorable elastically is disposed in the space portion. This flow rate control valve further includes a vertical hole 113 formed at the central part of base member 108, and a lift member 114 disposed in vertical hole 113 and having a nut portion 115 adapted to threadedly engage with the threaded portion of rotary shaft 111 of motor 110 and a pressure member 116 disposed at the lower end of lift member 114 and facing the upper surface of tube 112, wherein tube 112 is diametrically pressed or released by pressure member 116 disposed at the lower end of lift member 114 which is adapted to be moved up and down by the forward and reverse drive of motor 110. This configuration has an effect that the forward and reverse rotation of motor 110 presses or releases flow passage tube 112 thereby to set the flow passage area of tube 112 at a required level, so that the opening and closing of the flow passage and the flow rate can be controlled. By employing a stepping motor as motor 110, the amount of upward and downward movement of lift member 114 can be strictly controlled and the sectional shape of tube 112 can be delicately deformed by pressure member 116 thereby regulating the flow rate. Further, by forming rotary shaft 111 of motor 110 and nut portion 115 adapted to threadedly engage with rotary shaft 111 as those of a ball screw mechanism, a screw feeding substantially free of a backlash can be achieved, thereby allowing accurate fine adjustment of the flow rate. The ends of tube 112 are connected, through joints 117, to connecting portions 120, 121 which in turn are projected from base member 108 and connected to an inflow tube 118 and an outflow tube 119, respectively.

However, although the conventional flow rate controller described above can be designed to be compact, the tube in the flow rate controller is not primarily intended to repeatedly open and close the flow passage, and therefore has a problem of low endurance and cannot stand long-term use, resulting in a risk of breakage. Another problem is that the lack of endurance against the repetitive opening and closing operation makes the configuration not suitable for an automatic valve opening and closing operation and a manual opening and closing operation is required, with the result that the conventional flow rate controller cannot be used as an automatic control valve for carrying out feedback control of the flow rate. Further, since the pinch valve is not fixed to the tube 101 in a stable fashion, a load may be imposed on the opening and closing operation point of the tube 101 when stress is exerted on the pipeline. Especially in the case where stress is exerted on tube 101 in the direction of tension, the opening and closing operation point is forcibly moved, thereby posing the problem that tube 101 is may be damaged.

Additionally, in the conventional flow rate control valve described above, a connecting structure between the flow rate control valve and inflow tube 118 and outflow tube 119 is projected from the flow rate control valve. This poses a problem that the face-to-face distance of the valve (i.e. the length in the direction of the flow passage axis) is increased and the valve cannot be made compact and a problem that the projected portion can interfere with other piping devices and the device size with the flow rate controlled valve installed thereon is increased. Tube 112 is connected to inflow tube 118 and outflow tube 119 through connecting portions 120, 121 using joints 117 and simply fixed by joints 117. This poses a problem that tube 112 is low in sealability, and under a high internal pressure, may come off. Further, as understood from FIG. 7, inflow tube 118 and outflow tube 119 are connected with connecting portions 120, 121 by welding, thereby leading to problems that the job of connecting the flow rate control valve and inflow tube 118 and outflow tube 119 is bothersome and that the work quality variations among workers may cause, if the connection is insufficient, inflow tube 118 or outflow tube 119 to come off when a large amount of force is exerted on the tube in the tensioning direction thereof.

### SUMMARY OF THE INVENTION

Accordingly, it is an object of the present invention to provide a compact piping device having a short face-to-face length and a high sealability between parts of a connecting portion where a tube and a pipeline are connected to each other, in which a stress which may be exerted on the pipeline imposes no extraneous load on the tube.

In order to solve the problem described above, according to the present invention, there is provided a piping device, which includes: a body; a tube accommodated in the body and defining a flow passage; coupling members, each of the coupling members having an insert portion at an end thereof, the insert portion inserted into the tube in watertight state, a connecting portion at the other end thereof, and a flange portion at the central part thereof; and holding members, each of the holding members formed with a through hole at the central part thereof, wherein the through hole of each of holding members includes, at one end thereof, an expanded-diameter portion having a hole diameter larger than the remaining portion of the through hole, the insert portion of each of the coupling members being fitted into the expanded-diameter portion of the corresponding holding member with the tube passed through the through holes of the holding members and each of the insert portions of the coupling members inserted into each of the two ends of the tube, the flange portion of each of the coupling members and the corresponding holding member pressed into contact with each other being fitted in a fitting groove formed on the body.

Preferably, at least one of side walls of each fitting groove of the body or some surfaces of the side walls of the flange portion of each coupling member and each holding member which are in contact with the fitting groove is tapered such that the distance between the side walls is progressively reduced toward a bottom portion of the fitting groove.

In one embodiment, the piping device is a pinch valve, the body includes a linear groove for receiving the tube along the flow passage axis, and the fitting grooves formed at the two ends of the liner groove so as to be deeper than the linear groove, and the piping device further includes a pressing element for changing the opening area of the tube by pressing or releasing the tube, and a drive unit fixedly coupled to the upper part of the body and for moving the pressing element upward and downward thereby to press or release the tube.

In the pinch valve, the drive unit preferably includes a motor unit accommodated in an upper bonnet and a lower bonnet, and a stem for moving the pressing element upward and downward by driving the motor unit.

Preferably, the drive unit includes: a cylinder body having a cylinder portion formed therein and a cylinder cover integrally formed with the upper part of the cylinder body; a piston disposed in sliding contact with the inner peripheral surface of the cylinder portion so as to be movable upward and downward in sealed state and having a coupling portion suspended downward from the center thereof so as to extend in sealed state through a through hole formed at the center of the lower surface of the cylinder body; and air ports formed on the peripheral side surface of the cylinder body and communicating with a first space portion and a second space portion, respectively, the first space portion being defined by the bottom surface and the inner peripheral surface of the cylinder portion and the lower end surface of the piston, the second space portion being defined by the lower end surface of the cylinder cover, the inner peripheral surface of the cylinder portion and the upper surface of the piston, wherein the pressing element is fixed at the lower end of the coupling portion of the piston.

In another embodiment, the piping device is a tube pump.

Preferably, the tube is formed of ethylene propylene diene rubber (EPDM), fluoro rubber, silicon rubber or a composite material thereof, and the tube is formed of a composite material of polytetrafluoroethylene and silicon rubber.

### BRIEF DESCRIPTION OF THE DRAWINGS

The above and other objects, features and advantages of the present invention will be described in more detail below based on the preferred embodiments of the present invention with reference to the accompanying drawings, wherein:

FIG. 1 is a longitudinal sectional view showing an opened state of a piping device according to a first embodiment of the present invention;

FIG. 2 is an exploded perspective view showing a tube, coupling members and holding members before being assembled to a body;

FIG. 3 is a perspective view showing the tube, the coupling members and the holding members which are assembled in the body;

FIG. 4 is a longitudinal sectional view of a piping device according to a second embodiment of the present invention;

FIG. 5 is a longitudinal sectional view of a piping device according to a third embodiment of the present invention;

FIG. 6 is a perspective view of a conventional piping device having a tube; and

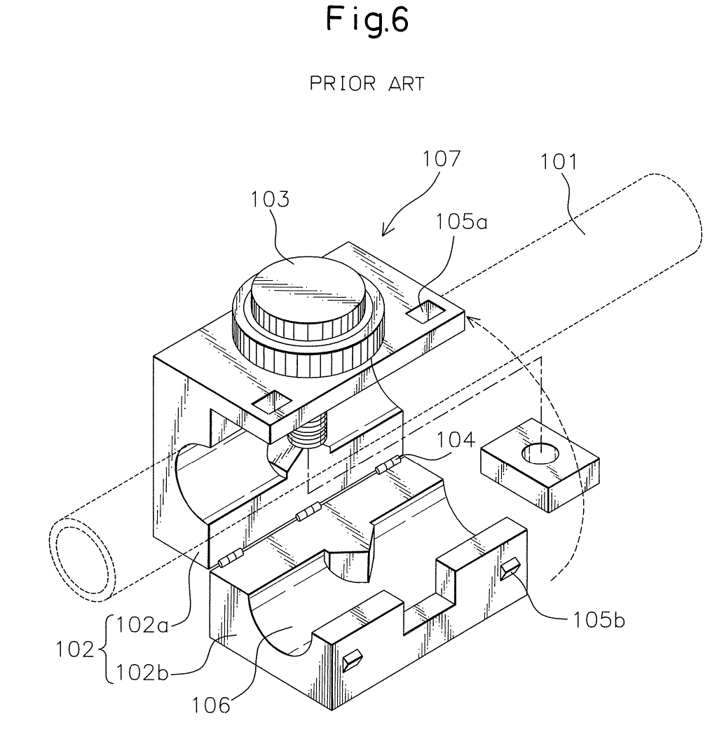

FIG. 7 is a longitudinal sectional view of a conventional fluid control valve having a tube.

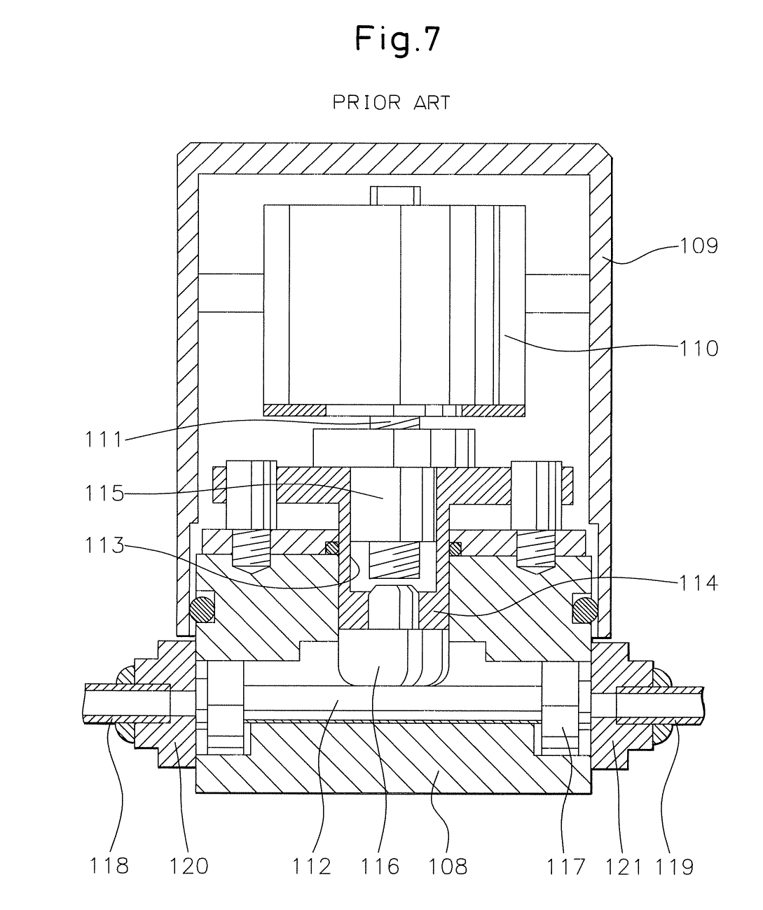

### DETAILED DESCRIPTION

### First Embodiment

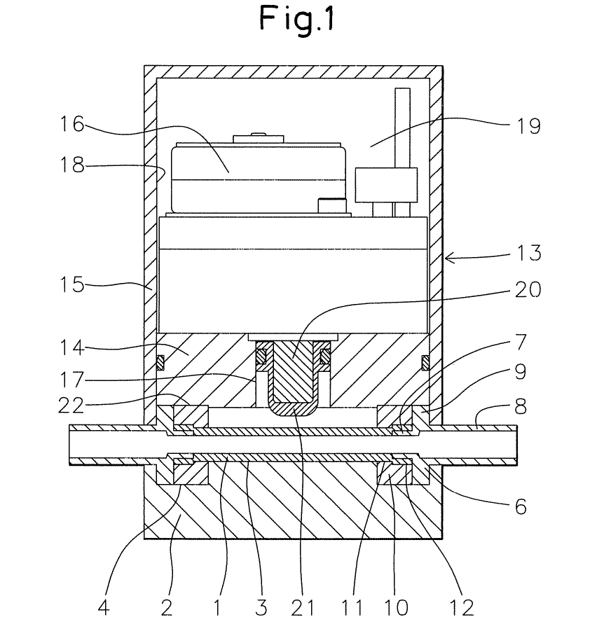

An electrically-driven pinch valve according to a first embodiment of the present invention will be described below with reference to FIGS. 1 to 3.

The pinch valve includes a tube 1, a body 2 having a flow passage axis, coupling members 6, holding members 10 and an electric drive unit 13.

Tube 1, which is made of a composite material of fluoro rubber and silicon rubber, is accommodated in the body 2 and defines a flow passage.

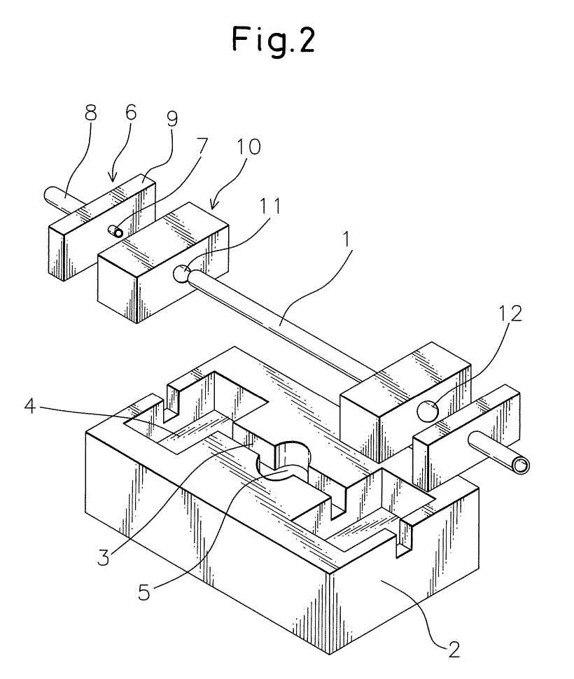

Body 2 is made of PVC and is formed on the flow passage axis thereof with a linear groove 3 of a rectangular section for receiving tube 1 therein. A fitting groove 4 of a rectangular section for receiving one of coupling members 6 and one of the holding members therein is formed at each end of linear groove 3 so as to be deeper than linear groove 3. At the central part of linear groove 3, an oblong groove 5 in which a pressing element 21 can move upward and downward is formed so as to have the same depth as that of linear groove 3 (see FIG. 2).

Coupling members 6 are made of PFA, and each of coupling members 6 has an insert portion 7 formed at one end thereof. The insert portion has an outer diameter larger than the inner diameter of tube 1 and substantially the same inner diameter as that of tube 1 and is adapted to be inserted into each of the two ends of tube 1. Further, each coupling member 6 is formed at the other end thereof with a tubular connecting portion 8 adapted to be connected with a tube extending from the pipeline, and also at the center part thereof with a flange portion 9 adapted to be fitted into corresponding fitting groove 4. Although connecting portion 8 is formed to be a tubular in this embodiment so that it can be connected with the pipeline by butt fusion, it may alternatively be provided with a joint or a thread, depending on the way how it is connected with the pipeline.

Holding members 10 are made of PVC, and each of holding members 10 is formed at the center part thereof with a through hole 11. Through hole 11 is formed at one end thereof with an expanded-diameter portion 12 having an inner diameter substantially equal to the outer diameter of tube 1 connected to insert portion 7 of coupling member 6.

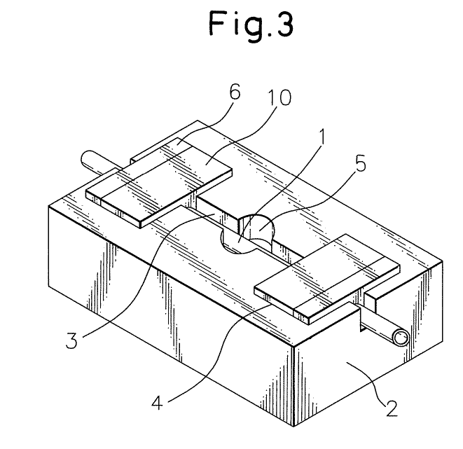

Coupling members 6 and holding members 10 are fitted into expanded-diameter portions 12 of holding members 10 with each of two ends of tube 1 passed through through hole 11 of each holding member 10 and insert portion 7 of each coupling member 6 inserted into each of the two ends of tube 1. Tube 1 is then inserted into linear groove 3 of body 2 and fixed therein with flange portion 9 of each coupling member 6 and each holding member 10 being pressed into contact with each other and fitted into corresponding fitting groove 4 of body 2 (the state shown in FIG. 3).

Flange portion 9 of each coupling member 6 and corresponding holding member 10 are formed to be substantially parallelopipedal when pressed into contact with each other, and are fitted in corresponding fitting groove 4 of body 2 in the state where they are pressed into contact with each other. Fitting grooves 4 of body 2 preferably have such a height as to fully accommodate each expanded-diameter portion 12 of holding member 10 therein. This makes it possible to uniformly apply a predetermined force to press the connected portion of tube 1 and insert portion 7 of coupling member 6, thereby uniformly sealing tube 1 along the entire periphery thereof. Flange portion 9 of each coupling member 6 and each holding member 10 preferably have a height slightly larger than the height of each fitting groove 4 of body 2 so that the upper parts of flange portion 9 and holding member 10 are slightly projected from the upper surface of body 2 when they are fitted in fitting groove 4 (see FIG. 3). In this case, the positioning of body 2 and electric drive unit 13 at the time of assembly can be facilitate by providing the lower surface of electric drive unit 13 with depressions 22 for the projected upper parts of flange portions 9 of coupling members 6 and holding members 10 to be fitted therein, respectively. The shape of flange portions 9 of coupling members 6 and holding members 10 as well as the shape of fitting grooves 4 are not limited as long as flange portion 9 of each coupling member 6 and corresponding holding member 10 pressed into contact with each other can be fitted in corresponding fitting groove 4. Preferably, at least one of the side walls of each fitting groove 4 of body 2 or some surfaces of the side walls of flange portion 9 of each coupling member 6 and each holding member 10 which are in contact with that fitting groove 4 is tapered such that the distance between the two side walls thereof are progressively reduced toward the bottom portion of fitting groove 4. This makes it easier to fit flange portion 9 of coupling member 6 and holding member 10 into corresponding fitting groove 4, thereby facilitating the assembly of the piping device. This taper may be formed either over the entire side wall preferably at a taper angle of 0.5 to 5°, or only on a part of the side wall or as a chamfer preferably at a taper angle of 20 to 60°.

Electric drive unit 13 is used for moving pressing element 21 upward and downward, and fixed in contact with the upper part of body 2 by means of a bolt and a nut, etc. (not shown). Electric drive unit 13 is configured of a lower bonnet 14 and an upper bonnet 15 and has arranged therein a motor unit 16 and a gear.

Lower bonnet 14 is made of PVC and has a plate-like shape. A through hole 17 is formed at the center of lower bonnet 14. Also, the lower surface of lower bonnet 14 is formed with depressions 22 adapted to be fitted by the upper parts of flange portions 9 of coupling members 6 and holding members 10, respectively.

Upper bonnet 15 is made of PVC. The lower surface of upper bonnet 15 is formed with an open depression 18, and when lower bonnet 14 is fitted on upper bonnet 15, a storage portion 19 is formed by the upper surface of lower bonnet 14 and the inner peripheral surface of depression 18 of upper bonnet 15.

Motor unit 16 is arranged in storage portion 19. Motor unit 16 includes a stepping motor, and a stem 20 coupled to the shaft of the motor through a gear is provided under motor unit 16. Stem 20 is arranged to be in through hole 17 of lower bonnet 14. Pressing element 21 is connected with the lower part of stem 20, so that by driving motor unit 16 to move stem 20 upward and downward, tube 1 can be pressed and released or opened by pressing element 21.

The portion of pressing element 21 pressing tube 1 is formed to have a hog-backed cross section. Pressing element 21 is fixed to the lower end of stem 20 at a right angle to tube 1. When the valve is closed, pressing element 21 is inserted into oblong groove 5 of body 2 to press tube 1. On the other hand, when valve is opened, pressing element 21 releases or opens tube 1 and is accommodated in through hole 17 of lower bonnet 14. Although pressing element 21 in this embodiment is fixed to the lower end of stem 20 and is moved upward and downward by electric drive unit 13 moving stem 20 upward and downward, stem 20 may be formed with an externally threaded portion and pressing element 21 formed on the inner periphery thereof with an internally threaded portion may be threadedly engaged with the lower part of stem 20, so that pressing element 21 can be moved upward and downward by electric drive unit 13 rotating stem 20 while holding pressing element 21 so as to be unrotatable.

Next, the operation of the piping device according to the first embodiment of the present invention will be described.

The electrically-driven pinch valve driven by electric drive unit 13 operates as described below.

When motor unit 16 of electric drive unit 13 drives stem 20 downward (rotates in the forward direction), pressing element 21 disposed on the lower part of stem 20 is moved down and deforms tube 1 thereby to change the opening area of the flow passage of tube 1. Thus, the flow rate of the fluid flowing through the pinch valve can be regulated. When stem 20 is further driven downward, pressing element 21 is moved down and presses tube 1 thereby to shut off the flow passage to be in fully closed state. On the other hand, when motor unit 16 drives stem 20 upward (rotates in the reverse direction), pressing element 21 disposed on the lower part of stem 20 is moved up and accommodated in through hole 17 of lower bonnet 14. Thus, the upward movement of stem 20 and pressing element 21 is stopped thereby to make the flow passage in a fully opened state (the state shown in FIG. 1).

The pinch valve according to the present invention has only a small number of parts for connecting tube 1 and the pipeline, and can be assembled by inserting the parts into each other or fitting them with each other. Thus, the assembly work can be easily carried out in a short time. As shown in FIG. 2, the parts can be formed in a simple shape without any need to form any threaded grooves therein, thereby making the machining of the parts easier. Further, the part of the valve connected with the pipeline is not projected from body 2, and the face-to-face length of the pinch valve (length in the direction of the flow passage axis) can be shortened and be compact. As a result, the installation space of the device on which the pinch valve is mounted can be reduced.

Since each coupling member 6 and corresponding holding member 10 pressed into contact with each other are fitted into corresponding fitting groove 4, tube 1 and insert portion 7 of coupling member 6 are positively kept in watertight state over the whole periphery by expanded-diameter portion 12 of holding member 10. The watertight state is further enhanced by the stepped portion between expanded-diameter portion 12 of holding member 10 and through hole 11. Therefore, if a high internal pressure is applied, a force is exerted so as to increase the sealability correspondingly. This eliminates a risk of fluid leakage and also prevents tube 1 from coming off from coupling members 6. Also, since each coupling member 6 and corresponding holding member 10 are fixed by body 2, the stress, if exerted on the pipeline in the tensioning or compressing direction, can be received by coupling member 6. Thus, no load is imposed on tube 1 and the pump can be used for a long time. Tube 1 and each coupling member 6 may be fitted with each other using an O-ring or the like disposed between them as required.

As understood from the foregoing description, tube 1 and the pipeline are kept in watertight state, and the space of the portion at which tube 1 and the pipeline are connected to each other can be reduced thereby to make electrically drive unit 13 compact. Further, the fine control of electric drive unit 13 can be easily carried out by controlling electrically driven motor unit 16, thereby exhibiting the superior effect of controlling the fluid flowing at a minuscule flow rate.

### Second Embodiment

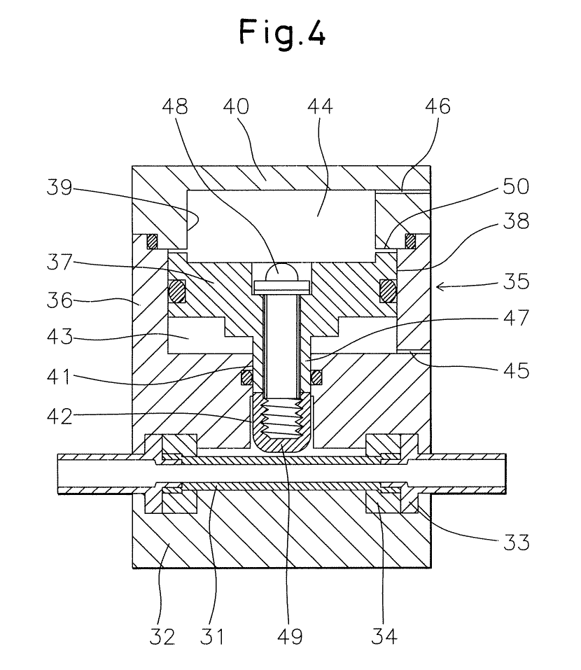

A pneumatically-driven pinch valve according to a second embodiment of the present invention will be described below with reference to FIG. 4.

The pinch valve includes a tube 31, a body 32, coupling members 33, holding members 34, and a pneumatic drive unit 35.

Tube 31, which is made of a composite material of fluoro rubber and silicon rubber, is accommodated in body 32 and defines a flow passage.

Body 32 is made of PVDF, coupling members 33 are made of PFA, and holding members 34 are made of PVDF. The configurations of body 32, coupling members 33 and holding members 34 are similar to those of the first embodiment and the description thereof will be omitted here.

Pneumatic drive unit 35 is used for moving a pressing element 49 upward and downward, and fixed in contact with the upper part of body 32 by means of a bolt and nut, etc. (not shown). Pneumatic drive unit 35 is configured of a cylinder body 36 and a piston 37, etc.

Cylinder body 36 is made of PVDF. Cylinder body 36 includes a cylinder portion 38 having a cylindrical space, and a cylinder cover 40 having a recess 39 open to the lower surface is fixed, through an O-ring, in contact with the upper part of cylinder body 36. A through hole 41 allowing a coupling portion 47 of piston 37 to extend therethrough and an oblong slit 42 for accommodating holding pressure member 49 therein are formed continuously at the central part of the lower surface of cylinder body 36. The peripheral side surface of cylinder body 36 is formed with air ports 45, 46 for introducing the compressed air, respectively, into a first space portion 43 defined by the inner peripheral surface and the bottom surface of cylinder portion 38 and the lower end surface of piston 37 described later and into a second space portion 44 defined by the inner peripheral surface of cylinder portion 38, the lower end surface of cylinder cover 40 and the upper end surface of piston 37.

Piston 37 is made of PVDF. Piston 37 is of a disk shape, and has an O-ring mounted on the peripheral surface thereof, so that it is fitted in cylinder portion 38 so as to be movable upward and downward in a sealed state on the inner peripheral surface of cylinder portion 38. Also, a coupling portion 47 is suspended downward from the center of piston 37, and passes through hole 41 formed at the central part of the lower surface of cylinder body 36 in a sealed state. Further, pressing element 49 is threadedly fixed to the forward end portion of a fixing bolt 48 extending through coupling portion 47. Pressing element 49 may be fixed to coupling portion 47 by pressure fitting, bonding or welding, with a pin or by any other means not specified.

Pressing element 49 is made of PVDF, and the portion of pressing element 21 pressing tube 31 is formed to have a hog-backed cross section. Also, pressing element 49 is fixed to coupling portion 47 of piston 37 at a right angle to tube 31. When the valve is closed, pressing element 49 is inserted into the oblong groove of body 32 to press tube 31. On the other hand, when the valve is opened, pressing element 49 releases or opens tube 31 and is accommodated in oblong slit 42 of cylinder body 36.

The procedure of assembling the pneumatically-driven pinch valve according to the second embodiment of the present invention is similar to that of the first embodiment, except that body 32 and pneumatic drive unit 35 are assembled by being fixed with a bolt and a nut, and therefore the description thereof will be omitted here.

Next, the operation of the pinch valve according to the second embodiment of the present invention will be described.

The pinch valve with the operating pressure supplied from an electropneumatic converter (not shown) operates as described below.

When the compressed air is supplied through air port 45 to first space portion 43, the compressed air in second space portion 44 is discharged through air port 46 while piston 37 begins to move upward under the pressure of the compressed air supplied to first space portion 43 thereby to move pressing element 49 upward through coupling portion 47 suspended from piston 37. Once the upper end surface of piston 37 comes into contact with stepped portion 50 of cylinder portion 38, the upward movement of piston 37 and pressing element 49 stops, and pressing element 49 is accommodated in through hole 41 of cylinder body 36 to make the valve in a fully opened state. On the other hand, when the compressed air is supplied through air port 46 to second space portion 44, the compressed air in first space portion 43 is discharged through air port 45 while piston 37 begins to move downward under the pressure of the compressed air supplied to second space portion 44 thereby to move pressing element 49 through coupling portion 47 suspended from piston 37. Once the lower end surface of piston 37 reaches the bottom surface of cylinder portion 38, the downward movement of piston 37 and pressing element 49 stops, and pressing element 49 presses tube 31 thereby to shut off the flow passage to be in a fully closed state. Pressing element 49 is moved upward and downward along with the upward and downward movement of piston 37, so that pressing element 49 deforms tube 31 to change the opening area of the flow passage of tube 31, thereby making it possible to adjust the flow rate of the fluid flowing through the pinch valve.

In the pinch valve according to the second embodiment, a spring (not shown) may be held and supported in second space portion 44 between the ceiling surface of cylinder portion 38 and the upper surface of piston 37, and also, a spring (not shown) may be held and supported in first space portion 43 between the bottom surface of cylinder portion 38 and the lower surface of piston 37. This configuration is preferable in view of the fact that by applying the urging force due to elasticity of the spring instead of supplying the working fluid, the normally-closed or normally-opened state can be realized without supplying the working fluid.

As understood from the foregoing description, the space of the portion at which tube 31 and the pipeline are connected to each other can be reduced thereby to make the air-driven pinch valve compact. Further, since the pinch valve is driven by air using pneumatic drive unit 35, it is not required to use any electric parts that may corrode in the pinch valve, thereby preventing the parts of the pinch valve from being corroded by the corrosive gas which otherwise might intrude when a corrosive fluid is supplied. The other operation of the second embodiment is similar to that of the first embodiment and therefore the description thereof will be omitted.

### Third Embodiment

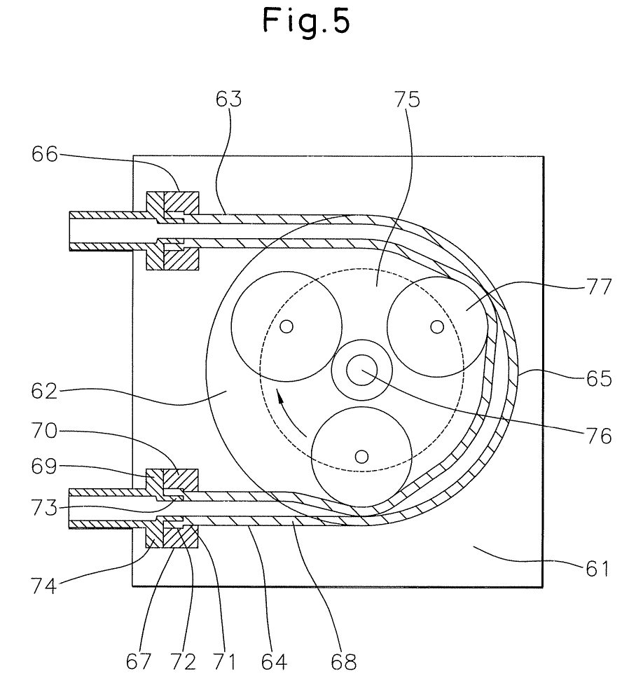

A tube pump according to a third embodiment of the present invention will be described below with reference to FIG. 5. The tube pump is also called a peristaltic pump.

The tube pump includes a body 61, a tube 68, coupling members 69, holding members 70, and a circular disk 75.

Body 61, together with a cover (not shown) removably attached to the side surface of body 61, constitutes a housing of the tube pump. Body 61 is formed with a circular groove 62 opening to the side surface (front side in FIG. 5) and two linear grooves 63, 64 extending from circular groove 62 toward one of the peripheral side surfaces of body 61. A support wall 65 for pressing tube 68 against rollers 77 described later is formed on the inner peripheral surface of circular groove 62. Also, fitting grooves 66, 67 having a rectangular section for receiving coupling member 69 and holding member 70 are formed at the ends of linear grooves 63, 64, respectively, so as to be deeper than linear grooves 63, 64.

Tube 68, which is made of a composite material of fluoro rubber and silicon rubber, is accommodated in linear groove 63, the inner periphery side of circular groove 62 and linear groove 64 of body 61 and defines a flow passage in body 61.

Coupling members 69 are made of PTFE, and holding members 70 are also made of PTFE. The configurations of coupling members 69 and holding members 70 are similar to those of the first embodiment and the description thereof will be omitted here. Tube 68 is held within body 62 by passing tube 68 through through hole 71 of each holding member 70, inserting insert portion 73 of each coupling member 69 into each end of tube 68 to connect each insert portion 73 to each end of tube 68, fitting insert portion 73 in expanded-diameter portion 72 of holding member 70, and fitting flange portion 74 of each coupling member 73 and corresponding holding member 70 pressed into contact with each other in the corresponding one of fitting grooves 66, 67 of body 61.

Circular disk 75 is provided to be rotatable about drive shaft 76, and three rollers 77 are supported by circular disk 75 so as to be rotatable. Rollers 77 are equally spaced along the outer periphery of circular disk 75. Circular disk 75 is supported by body 61 and the cover (not shown) through drive shaft 76, which is rotationally driven by a motor (not shown). Rollers 77 may be employed, or four or more rollers 77 may be employed.

Next, the operation of the tube pump according to the third embodiment of the present invention will be described.

When drive shaft 76 is driven and rotated by the motor (not shown) thereby to rotate circular disk 75 in the direction of arrow, rollers 77, while pressing tube 68 against support wall 65, rotationally move the pressure positions (i.e. move the pressure positions along support wall 65). As a result, the liquid in tube 68 is transported under pressure in the direction of arrow. Here, focusing attention on a part of tube 68, the part of tube 68 is collapsed when it is pressed by one of rollers 77. Once one roller 77 leaves the part of tube 68, the part of tube 68 returns to the original state. Further, when next roller 77 arrives at the part, the same action is repeated. In this way, three rollers 77 transport the fluid in tube 68 under pressure while repeating the actions of pressing and releasing or opening tube 68 alternately.

While the present invention has been described with reference to several embodiments, it is not limited to these embodiments. Although the pinch valve and the tube pump have been employed as particularly preferable examples of the piping device according to the present invention, the present invention is not particularly limited to these embodiments as long as it has the aforementioned configuration according to the present invention. In the case of the pinch valve, it is preferably driven electrically as shown in FIG. 1 or pneumatically as shown in FIG. 4.

The tube material is not particularly limited and may be an elastic material such as ethylene propylene diene rubber (EPDM), silicon rubber, fluoro rubber or a composite material thereof. Especially, a composite material of fluoro rubber and silicon rubber having a high endurance against the repeated opening and closing operation is suitable. Polytetra fluoro ethylene (hereinafter referred to as PTFE) is preferable as fluoro rubber. Also, the tube production method is not particularly limited and the tube may be produced by stacking a plurality of PTFE sheets impregnated with silicon rubber to a desired thickness.

Further, materials of the body, the coupling members and the holding members, etc., of the piping device according to the present invention may be any resin material such as polyvinyl chloride (hereinafter referred to as PVC), polypropylene or polyethylene, as long as it is resin material. Especially in the case where a corrosive fluid is used, fluoro resin such as PTFE, polyvinylidene fluoride or tetrafluoroethylene-perfluoroalkylvinylether copolymer (hereinafter referred to as PFA) is preferable. The fluoro resin would be suitable because it can be used for a corrosive fluid and eliminate possibility of corrosion of the piping device against any intruding corrosive gas.

The present invention has the structure described above and achieves the superior effects described below.

(1) The connecting portion between the pinch valve (tube pump) and the pipeline is not projected and therefore, a face-to-face length of the valve can be shortened and be compact, so that the installation space of the device on which the pinch valve can be reduced.

(2) Since the tube and the coupling members are fixed by the holding members in watertight fashion, Even under a high internal pressure, there is no risk of fluid leakage and the tube is prevented from coming off from the coupling members, if a high internal pressure is applied.

(3) Any stress exerted on the pipeline can be received by the coupling members and therefore, no load is imposed on the tube, thereby assuring longtime use.

(4) The number of parts can be reduced and therefore, the assembly work can be easily accomplished within a short period of time.

(5) The parts can be formed in a simple shape and therefore, can be easily machined.

1. A piping device comprising:
a body;
a tube accommodated in the body and defining a flow passage;
coupling members, each of said coupling members having an insert portion at one end thereof, said insert portion inserted into said tube in watertight state, a connecting portion at the other end thereof, and a flange portion at the central part thereof; and
holding members, each of said holding members formed with a through hole at the central part thereof,
wherein said through hole of each of said holding members includes, at one end thereof, an expanded-diameter portion having a hole diameter larger than the remaining portion of said through hole, said insert portion of each of said coupling members being fitted into said expanded-diameter portion of the corresponding holding member with said tube passed through said through holes of said holding members and each of said insert portions of said coupling members inserted into each of the two ends of said tube, said flange portion of each of said coupling members and the corresponding holding member pressed into contact with each other being fitted in a fitting groove formed on said body.

2. The piping device according to claim 1, wherein at least one of side walls of each fitting groove of said body or some surfaces of the side walls of said flange portion of each coupling member and each holding member which are in contact with said fitting groove is tapered such that the distance between the side walls is progressively reduced toward a bottom portion of said fitting groove.

3. The piping device according to claim 1, wherein said piping device comprises a pinch valve,
wherein said body includes a linear groove for receiving said tube along said flow passage axis, and said fitting grooves formed at the two ends of said linear groove so as to be deeper than said linear groove, and
wherein said pinch valve further comprises:
a pressing element for changing the opening area of said tube by pressing or releasing said tube; and
a drive unit fixedly coupled to the upper part of said body and for moving said pressing element upward and downward thereby to press or release said tube.

4. The piping device according to claim 2, wherein said piping device comprises a pinch valve,
wherein said body includes a linear groove for receiving said tube along said flow passage axis, and said fitting grooves formed at the two ends of said linear groove so as to be deeper than said linear groove, and
wherein said pinch valve further comprises:
a pressing element for changing the opening area of said tube by pressing or releasing said tube; and
a drive unit fixedly coupled to the upper part of said body and for moving said pressing element upward and downward thereby to press or release said tube.

5. The piping device according to claim 3, wherein said drive unit includes a motor unit accommodated in an upper bonnet and a lower bonnet, and a stem for moving said pressing element upward and downward by driving said motor unit.

6. The piping device according to claim 4, wherein said drive unit includes a motor unit accommodated in an upper bonnet and a lower bonnet, and a stem for moving said pressing element upward and downward by driving said motor unit.

7. The piping device according to claim 3, wherein said drive unit comprises:
a cylinder body having a cylinder portion formed therein and a cylinder cover integrally formed with the upper part of said cylinder body;
a piston disposed in sliding contact with the inner peripheral surface of said cylinder portion so as to be movable upward and downward in sealed state and having a coupling portion suspended downward from the center thereof so as to extend in sealed state through a through hole formed at the center of the lower surface of said cylinder body; and
air ports formed on the peripheral side surface of said cylinder body and communicating with a first space portion and a second space portion, respectively, said first space portion being defined by the bottom surface and the inner peripheral surface of said cylinder portion and the lower end surface of said piston, said second space portion being defined by the lower end surface of said cylinder cover, the inner peripheral surface of said cylinder portion and the upper surface of said piston,
wherein said pressing element is fixed to the lower end of said coupling portion of said piston.

8. The piping device according to claim 4, wherein said drive unit comprises:
a cylinder body having a cylinder portion formed therein and a cylinder cover integrally formed with the upper part of said cylinder body;
a piston disposed in sliding contact with the inner peripheral surface of said cylinder portion so as to be movable upward and downward in sealed state and having a coupling portion suspended downward from the center thereof so as to extend in sealed state through a through hole formed at the center of the lower surface of said cylinder body; and
air ports formed on the peripheral side surface of said cylinder body and communicating with a first space portion and a second space portion, respectively, said first space portion being defined by the bottom surface and the inner peripheral surface of said cylinder portion and the lower end surface of said piston, said second space portion being defined by the lower end surface of said cylinder cover, the inner peripheral surface of said cylinder portion and the upper surface of said piston,
wherein said pressing element is fixed to the lower end of said coupling portion of said piston.

9. The piping device according to claim 1, wherein said piping device comprises a tube pump.

10. The piping device according to claim 2, wherein said piping device comprises a tube pump.

11. The piping device according to claim 1, wherein said tube comprises ethylene propylene diene rubber, fluoro rubber, silicon rubber or a composite material thereof.

12. The piping device according to claim 1, wherein said tube comprises a composite material of polytetrafluoroethylene and silicon rubber.

13. The piping device according to claim 2, wherein said tube comprises a composite material of polytetrafluoroethylene and silicon rubber.

14. The piping device according to claim 3, wherein said tube comprises a composite material of polytetrafluoroethylene and silicon rubber.

15. The piping device according to claim 5, wherein said tube comprises a composite material of polytetrafluoroethylene and silicon rubber.

16. The piping device according to claim 7, wherein said tube comprises a composite material of polytetrafluoroethylene and silicon rubber.
